(19) United States
(12) Patent Application Publication
(10) Pub. No.: US 2016/0247204 A1
(43) Pub. Date: Aug. 25, 2016

(54) Identifying Additional Advertisements Based on Topics Included in an Advertisement and in the Additional Advertisements

(71) Applicant: Facebook, Inc., Menlo Park, CA (US)

(72) Inventors: Seyed Mohsen Amiri, Sunnyvale, CA (US); Daniel Tam, San Francisco, CA (US); Tianshi Gao, Fremont, CA (US)

(21) Appl. No.: 14/628,160

(22) Filed: Feb. 20, 2015

(51) Int. Cl. G06Q 30/02; G06F 17/30

(52) U.S. Cl. CPC G06Q 30/0269; G06F 17/3089

(57) ABSTRACT

An online system maintains topic vectors associated with various content items, where a vector associated with a content item indicates a topic vector of a content item. Words in a content item and context traits describing presentation of the words in the content item are used by the online system to determine a topic vector associated with the content item. When a subject content item for display, the online system determines the topic vector associated with the subject content item and identifies topic vectors associated with other content items nearest to the topic vector associated with the subject content item in a vector space through application of one or more clustering algorithms to the topic vectors. Content items associated with the identified topic vectors are indicated as similar to the subject content item by the online system.

### BACKGROUND

The present disclosure generally relates to presentation of content to users of an online system, and in particular, to selecting content for users of the online system based on topics associated with various content items.

An online system allows users to connect to and to communicate with other users of the online system. Users create profiles on an online system that are tied to their identities and include information about the users, such as interests and demographic information. The users may be individuals or entities such as corporations or charities. Content items are presented to various users by the online system to encourage users to interact with the online system.

Additionally, entities (e.g., a business) may present content items to online system users to gain public attention for products or services or to persuade online system users to take an action regarding products or services provided by the entity. An entity may create a campaign including multiple content items for presentation to users of the online system, where content items in a campaign may be associated with different targeting criteria to allow presentation of different content items in the campaign to online system users having different characteristics. Many online systems may receive compensation from an entity for presenting certain types of content items provided by the entity to online system users. Frequently, online systems charge an entity for each presentation of certain types of content to an online system user (e.g., each “impression” of the content) or for each interaction with the certain types of content by online system users.

When selecting content for presentation to a user, a conventional online system often accounts for interactions between the user and content items previously presented to the user by the online system. For example, if a user previously interacted with a content item associated with an entity, the online system is more likely to select additional content items associated with the entity for presentation to the user. Accounting for a user's prior interactions with content items allows a conventional online system to increase the likelihood of a user interacting with content subsequently presented to the user by the online system.

However, selecting content for presentation to an online system user based on user interaction with presented content may limit the content presented to the user by the online system. For example, if a content item associated with an entity is presented to a user and the user interacts with the content item, a conventional online system selects additional content items associated with the entity for presentation to the user. While the user may be presented with content items associated with the entity, such conventional online systems may limit presentation of content items associated with other entities having similar characteristics to the entity but associated with content items with which the user has not previously interacted. For example, if the other entity provides products similar to those provided by the entity associated with content items with which the user has previously interacted, conventional online systems selecting content items based on user interactions may fail to present the user with content items associated with the other entity.

### SUMMARY

An online system, such as a social networking system, selects and provides content items to its users. For example, an online system selects content items, such as advertisements, for presentation to a user based on characteristics of the user and characteristics of various content items maintained by the online system. To provide a user with content items with which the user is more likely to interact, the online system maintains multiple content items, each associated with a vector representing topics included in the content item. For example, the online system includes multiple advertisements and maintains a vector associated with each advertisement. A vector associated with a content item represents the content item in a topic space. For example, the vector associated with a content item has a direction based on the topics identified from the content item; however, the direction associated with a vector may be determined using any suitable method. In various embodiments, the online system extracts text objects from a content item using any suitable method and determines topics associated with the content item from the extracted text objects. From the determined topics, the online system determines the vector associated with the content item. In various embodiments, the online system maintains vectors associated with various content items in a database.

When the online system receives a subject content item for presentation to a user of the online system, the online system extracts text objects from the content item and determines a vector associated with the subject content item based on the extracted text objects. Based on distances between the vector associated with the subject content item and vectors associated with other content items maintained by the online system, the online system identifies content items as similar to the subject advertisement. For example, the online system identifies content items associated with vectors less than a threshold distance from the vector associated with the subject content item as similar to the subject content item. In various embodiments, any suitable clustering method may be used to identify content items similar to a subject content item based on vectors in a topic space associated with the subject content item and other content items. When selecting content items for presentation to a user, the online system may use similarity between the subject content item and other content items to identify content items with which the user is more likely to interact.

Accounting for similarity between a subject content item for presentation to a user and other content items based on topics identified from the subject content and other content items allows an online system to better identify content items from a large number of stored content items with which the user is likely to interact. As the online system maintains an increasingly large number of content items, identifying content items similar to a subject content item for presentation to the user allows the online system to more efficiently identify content items for presentation to a user. Comparing vectors associated with content items based on topics included in the content items rather than directly comparing the content items allows the online system to more quickly identify similar content items.

### BRIEF DESCRIPTION OF THE DRAWINGS

FIG. 1 is a block diagram of a system environment in which an online system operates, in accordance with an embodiment of the invention.

FIG. 2 is a block diagram of an online system, in accordance with an embodiment.

FIG. 3 is a process flow diagram illustrating determination of similarity between content items based on topics included in the content items, in accordance with an embodiment.

FIG. 4 is a flowchart of a method for determining similarity between content items based on topics extracted from various content items, in accordance with an embodiment of the invention.

FIG. 5 is an example of generating a topic vector associated with a content item, in accordance with an embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

### System Architecture

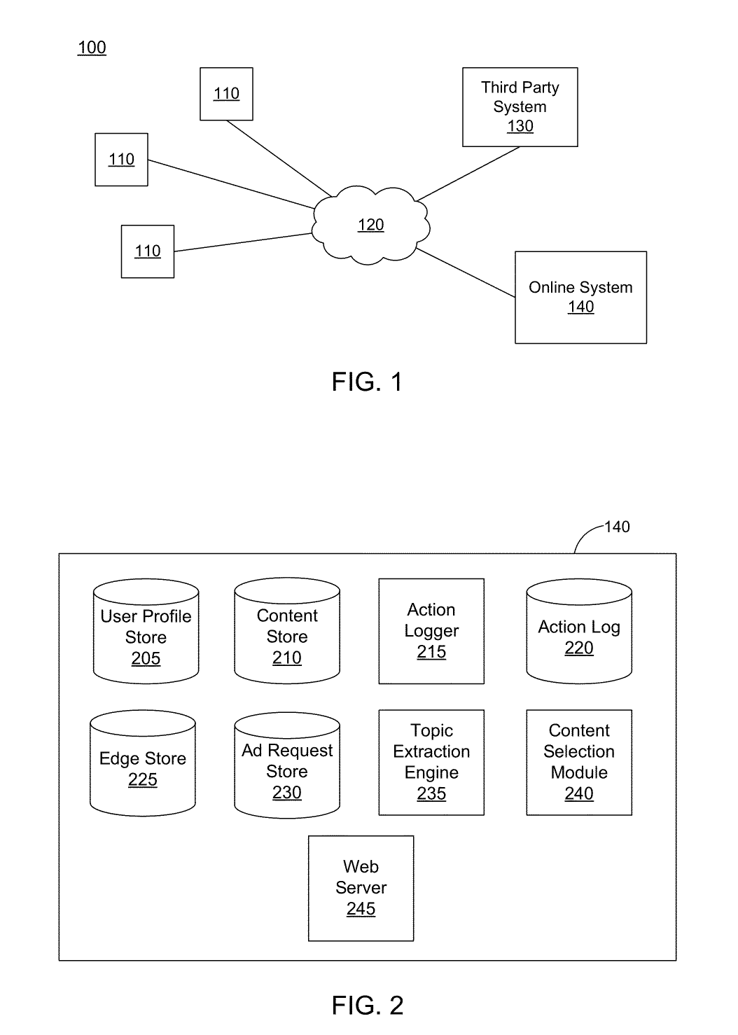

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. In some embodiments, the online system 140 is a social networking system.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. For example, the online system 140 is a social networking system. The online system 140 shown in FIG. 2 includes a user profile store 205, a content store 210, an action logger 215, an action log 220, an edge store 225, an advertisement request (“ad request”) store 230, a topic extraction engine 235, a content selection module 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, a message between users through a messaging application associated with the online system 140, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of the online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 115 for storing in the action log 220 by the application for recordation and association with the user by the online system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The online system 140 includes a topic extraction engine 235, which identifies one or more topics associated with content items from the content store 210 as well as topics associated with ad requests from the ad request store 230. To identify topics associated with content items (which may include ad requests), the topic extraction engine 235 identifies anchor terms included in a content item and determines a meaning of the anchor terms as further described in U.S. patent application Ser. No. 13/167,701, filed Jun. 24, 2011, which is hereby incorporated by reference in its entirety. For example, the topic extraction engine 235 determines one or more topics associated with a content item maintained in the content store 210. The one or more topics associated with a content item are stored and associated with an object identifier corresponding to the content item. Similarly, the topic extraction engine 235 determines one or more topics associated with an ad request maintained in the ad request store 230 and stores the determined topics in association with the ad request. In various embodiments, associations between identifiers of content items or ad requests and topics are stored in the topic extraction engine 235 or in the content store 210 or the ad request store 230 to simplify retrieval of one or more topics associated with an identifier of a content item or an ad request or retrieval of content item identifiers or ad request identifiers associated with a specified topic. Structured information associated with a content item or an ad request may also be used to extract a topic associated with the content item or ad request.

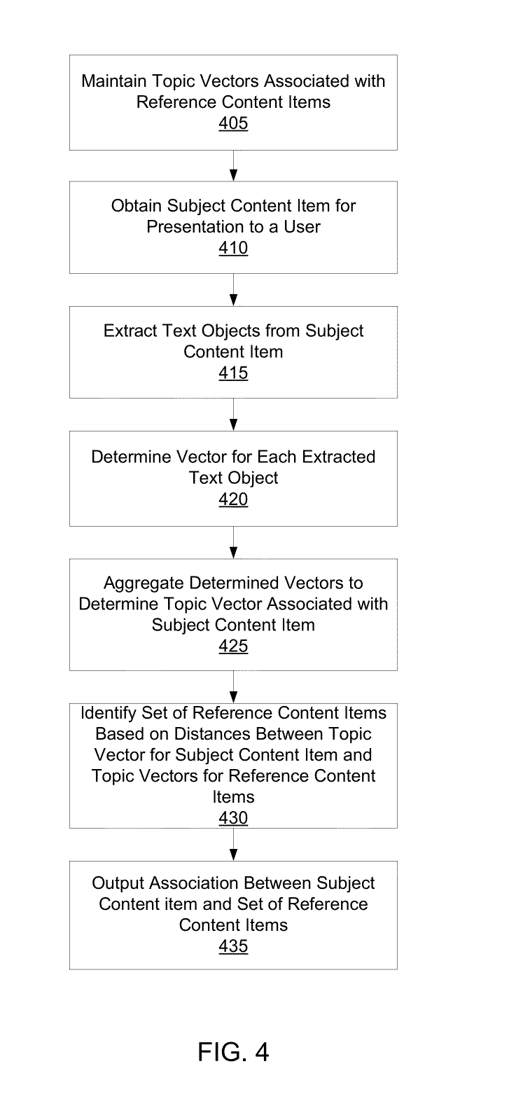

In various embodiments, the topic extraction engine 235 extracts text objects from a content item or an ad request and determines a topic associated with the content item or the ad request based on the extracted text objects. Text objects may be extracted from various components of a content item. For example, text objects are extracted from targeting criteria included in an ad request, text content included in a content item or in an ad request, content associated with a content item or ad request (e.g., content included in a landing page specified by an ad request). Additionally, the topic extraction engine 235 may extract text objects from images included in a content item through optical character recognition, or other suitable methods, or by analyzing video or audio data included in a content item. Extraction of text objects from a content item is further described below in conjunction with FIG. 4.

Based on text objects extracted from a content item, which may be an ad request, the topic extraction engine 235 generates a topic vector associated with the content item. For example, the topic extraction engine 235 uses a word to vector algorithm, or other suitable method, to represent various text objects as vectors in a high-dimensional Euclidean space (e.g., between 50 and upwards of 600 dimensions in the Euclidean space), as further described below in conjunction with FIG. 4. After determining at least a threshold number of vectors from text objects extracted from a content item, the topic extraction engine 235 generates a topic vector associated with the content item. For example, the topic extraction engine 235 generates the topic vector after determining a vector representing each text object extracted from the content item. The topic extraction engine 235 determines topic vectors for various content items and associates a topic vector with a content item.

The content selection module 240 selects one or more content items for communication to a client device 110 to be presented to a user. Content items eligible for presentation to the user are retrieved from the content store 210, from the ad request store 230, or from another source by the content selection module 240, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 240 includes content items eligible for presentation to the user in one or more selection processes, which identify a set of content items for presentation to the viewing user. For example, the content selection module 240 determines measures of relevance of various content items to the user based on characteristics associated with the user by the online system 140 and based on the user's affinity for different content items. Based on the measures of relevance, the content selection module 240 selects content items for presentation to the user. As an additional example, the content selection module 240 selects content items having the highest measures of relevance or having at least a threshold measure of relevance for presentation to the user. Alternatively, the content selection module 240 ranks content items based on their associated measures of relevance and selects content items having the highest positions in the ranking or having at least a threshold position in the ranking for presentation to the user.

Content items selected for presentation to the user may include ad requests or other content items associated with bid amounts. The content selection module 240 uses the bid amounts associated with ad requests when selecting content for presentation to the viewing user. In various embodiments, the content selection module 240 determines an expected value associated with various ad requests (or other content items) based on their bid amounts and selects content items associated with a maximum expected value or associated with at least a threshold expected value for presentation. An expected value associated with an ad request or with a content item represents an expected amount of compensation to the social networking system 140 for presenting an ad request or a content item. For example, the expected value associated with an ad request is a product of the ad request's bid amount and a likelihood of the user interacting with the ad content from the ad request. The content selection module 240 may rank ad requests based on their associated bid amounts and select ad requests having at least a threshold position in the ranking for presentation to the user. In some embodiments, the content selection module 240 ranks both content items not associated with bid amounts and ad requests in a unified ranking based on bid amounts associated with ad requests and measures of relevance associated with content items and ad requests. Based on the unified ranking, the content selection module 240 selects content for presentation to the user. Selecting ad requests and other content items through a unified ranking is further described in U.S. patent application Ser. No. 13/545,266, filed on Jul. 10, 2012, which is hereby incorporated by reference in its entirety.

For example, the content selection module 240 receives a request to present a feed of content to a user of the online system 140. The feed may include one or more advertisements as well as content items, such as stories describing actions associated with other online system users connected to the user. The content selection module 240 accesses one or more of the user profile store 205, the content store 210, the action log 220, and the edge store 225 to retrieve information about the user. For example, stories or other data associated with users connected to the identified user are retrieved. Additionally, one or more advertisement requests (“ad requests”) may be retrieved from the ad request store 230 The retrieved stories, ad requests, or other content items, are analyzed by the content selection module 240 to identify candidate content that is likely to be relevant to the identified user. For example, stories associated with users not connected to the identified user or stories associated with users for which the identified user has less than a threshold affinity are discarded as candidate content. Based on various criteria, the content selection module 240 selects one or more of the content items or ad requests identified as candidate content for presentation to the identified user. The selected content items or ad requests are included in a feed of content that is presented to the user. For example, the feed of content includes at least a threshold number of content items describing actions associated with users connected to the user via the social networking system 140.

In various embodiments, the content selection module 240 presents content to a user through a newsfeed including a plurality of content items selected for presentation to the user. One or more advertisements may also be included in the feed. The content selection module 240 may also determine the order in which selected content items or advertisements are presented via the feed. For example, the content selection module 240 orders content items or advertisements in the feed based on likelihoods of the user interacting with various content items or advertisements.

When selecting content items for presentation to the user, the content selection module 240 accounts for topics associated with content items in various embodiments. In some embodiments, after identifying a subject content item for presentation to a user, the content selection module 240 identifies a topic vector associated with the subject content item by the topic extraction engine 235 and compares the topic vector associated with the subject content item to topic vectors associated with additional content items. For example, the content selection module 240 determines distances between the topic vector associated with the subject content item and topic vectors associated with reference content items included in the content store 210 by the topic extraction engine 235. As further described below, based on the distances between the topic vector associated with the subject content item and topic vectors associated with reference content items included in the content store 210, the content selection module 240 identifies reference content items that are similar to the subject content item, as further described below in conjunction with FIG. 4. In some embodiments, the content selection module 240 increases measures of relevance associated with reference content items identified as similar to the subject content item, increasing the likelihood that reference content items similar to the subject content item are presented to the user. In other embodiments, the content selection module 240 identifies candidate content items from the reference content items identified as similar to the subject content item and selects one or more of the candidate content items as described above.

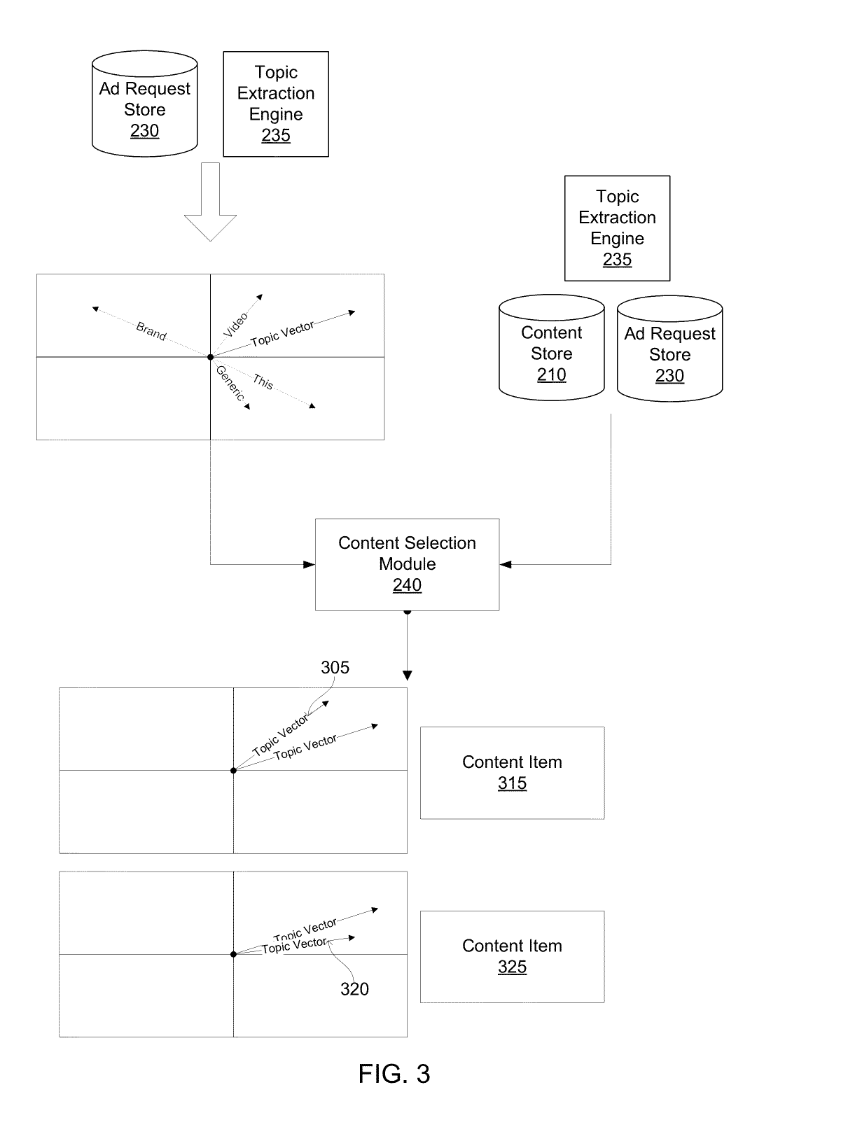

In one embodiment, the online system 140 allows its users to exchange messages with each other and presents a user with a thread including multiple messages exchanged between users. For example, the thread includes messages exchanged between the user and an additional user. Alternatively, the thread includes messages between the user and multiple additional users. An application associated with the online system 140 may execute on client devices 110 associated with various users; the application communicates messages received from a user to the online system 140 for presentation to one or more additional users via a thread and presents messages received from one or more other users to the user via the online system 140 to the user via a thread. In this embodiment, the content selection module 240 may include one or more advertisements or selected content items, as further described below in conjunction with FIGS. 3 and 4, in a thread presented to a user along with messages for presentation to the user.

The web server 245 links the online system 140 via the network 120 to the one or more client devices 110, as well as to the one or more third party systems 130. The web server 245 serves web pages, as well as other content, such as JAVA®, FLASH®, XML and so forth. The web server 245 may receive and route messages between the social networking system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

Identifying Additional Content Items Based on Topics Associated with a Content Item

FIG. 3 is a process flow diagram illustrating one embodiment of determining similarity between content items based on topics included in the content items. In various embodiments, different or additional components may be used by the online system 140 to determine similarity between content items than those described in conjunction with FIG. 3. For purposes of illustration, FIG. 3 shows determination of similarity between ad requests; however, similar components may be used to determine similarity between content items.

In the example shown by FIG. 3, the topic extraction engine 235 determines a topic vector 305 associated with a subject ad request from the ad request store 230 for presentation to a user of the online system 140. For example, the subject ad request is an ad request previously presented to a user of the online system 140 or is an ad request previously selected for presentation to the user of the online system 140. As further described below in conjunction with FIG. 4, the topic vector is determined by the topic extraction engine 235 extracting text objects from the subject ad request and applying a word to vector algorithm to determine vectors corresponding to the extracted text objects. From the determined vectors, the topic extraction engine 235 determines the topic vector 305 associated with the subject ad request, as further described in conjunction with FIG. 4. The topic extraction engine 235 may determine the topic vector 305 when the subject ad request is identified for presentation to a user, when the subject ad request is received by the online system 140, or based on any suitable criteria.

The subject ad request is identified by the content selection module 240, which retrieves topic vectors associated with reference ad requests or reference content items by the topic extraction engine 235. Topic vectors associated with the reference ad requests or the reference content items are determined by the topic extraction engine 235 using the process to determine the topic vector associated with the subject ad request. The topic vectors associated with the reference content items or the reference ad requests may be included in the content store 210, in the ad request store 230, in the topic extraction engine 235, or in any other suitable location. In various embodiments, topic vectors associated with reference ad requests or with reference content items are determined by the topic extraction engine 235 when the content selection module 240 identifies or requests reference content items or reference ad request. Alternatively, the topic extraction engine 235 determines topic vectors associated with reference content items or reference ad requests when the candidate ad requests or candidate content items are received by the online system 140 and stores the topic vectors in association with the reference content items or reference ad requests.

As further described below in conjunction with FIG. 4, the content selection module 240 identifies reference content items or reference ad requests similar to the subject ad request based on the topic vector 305 associated with the subject ad request. In various embodiments, the content selection module 240 determines distances between topic vectors associated with various reference content items or reference ad requests and the topic vector 305 associated with the subject ad request and identifies reference ad requests or reference content items as similar to the subject ad request based on the distances. For example, reference ad requests associated with topic vectors having less than a threshold distance to the topic vector 305 associated with the subject ad request as similar to the subject ad request. In the example of FIG. 3, the reference ad request 310 is associated with a topic vector 315 within the threshold distance of the topic vector 305 associated with the subject ad request and the reference ad request 320 is also associated with a topic vector 325 within the threshold distance of the topic vector 305 associated with the subject ad request. Hence, the content selection module 240 outputs information identifying the reference ad request 310 and the reference ad request 320 as similar to the subject ad request. For example, information associating the reference ad request 310 and the reference ad request 320 as similar to the subject ad request is stored in association with the subject ad request.

FIG. 4 is a flowchart of one embodiment of a method for determining similarity between content items based on topics extracted from various content items. In various embodiments, the method may include different and/or additional steps than those described in conjunction with FIG. 4. Additionally, in some embodiments, steps of the method may be performed in different orders than the order described in conjunction with FIG. 4.

The online system 140 maintains 405 topic vectors associated with a plurality of reference content items stored or associated with the online system 140, which may include one or more ad requests. A topic vector associated with a reference content item represents the reference content item in a topic vector space based on topics included in the reference content item. Hence, the topic vector identifies a topic associated with a content item based on the content of the content item.

To determine a topic vector maintained 405 for a reference content item, the online system 140 extracts text objects, which are words or phrases, from content included in the content request. The text objects are extracted from text included in the content items, and may also be extracted from other types of content included in a content item in some embodiments. For example, the online system 140 may also extract text objects from other types of content included in the reference content item or included in content associated with the reference content item. For example, the online system 140 identifies text objects from images included in the reference content item by applying one or more optical character recognition methods to image data included in the reference content item. As another example, the online system 140 applies one or more image processing methods to image data included in the reference content item to identify features of the image data and identifies text objects associated with the features from information associating features with text objects. Similarly, the online system 140 may identify text objects based on features or text extracted from video data included in the content item through any suitable image processing or video processing methods. In some embodiments, image data included in the content item has one or more tags identifying subject matter in the image data (e.g., tags provided by a user or entity from which the image data was obtained), and text objects are identified as one or more of the tags included in the image. Additionally, a landing page associated with a content item may be accessed by the online system 140, which extracts text objects from content included on the landing page. If the content item is an ad request, text objects may be extracted from targeting criteria included in the ad request.

A text object extracted from content associated with the content item includes one or more words as well as information describing the content from which the text object was extracted. In some embodiments, a text object includes one or more words and a tag associated with the one or more words describing content from which the one or more words were extracted. For example, a text object is the phrase “coffee shop” associated with a tag “Top-middle/image” indicating that the phrase “coffee shop” was extracted from a top middle portion of an image included in the content item. In some embodiments, information included in a text object specifies a font type, a font color, a font size, grammatical classification, or other characteristics of text in the content item from which one or more words in the text object were extracted. Any suitable information describing content from which words in a text object were extracted from the content item may be stored in the text object as context traits of the words in the text object; hence, a context trait included in a text object describes one or more characteristics of content from the content item from which words in the text object were extracted.

For various text objects extracted from the content item, the online system 140 determines topic vectors describing the text objects in a topic space. In some embodiments, the online system 140 determines a topic vector for each text object extracted from the content item. Alternatively, the online system 140 determines topic vectors for at least a threshold number of text objects extracted from the content item. However, in other embodiments, the online system 140 determines topic vectors for text objects having specific context traits. In various embodiments, the online system 140 applies a word to vector process (e.g., a bag of words process, a skip-gram process, a combination of a bag of words and a skip-gram process, an n-gram process etc.) to a text object to determine a topic vector corresponding to the text object.

For example, a word to vector process used by the online system 140 is a model initially applied to a training set of text data to identify a vocabulary of words and determine vector representations of the words in the vocabulary. The training set of text data may be retrieved from one or more third party systems 130, from data maintained by the online system 140, or from any suitable source. Various training sets of text data may be used in different embodiments to train the model; for example, a training set of text data including content from various ad requests may be used in implementations where at least a threshold number or percentage of the content items maintained by the online system 140 are ad requests. When the model is applied to text data (e.g., text in the training set of text data), vectors associated with words within a threshold distance of each other or having a specific grammatical relationship with each other are positioned so the vectors have a similar direction in the topic space. In various embodiments, the model applied by the online system 140 uses individual word or groups of words (e.g., groups of two words, groups of three words) to determine a vector.

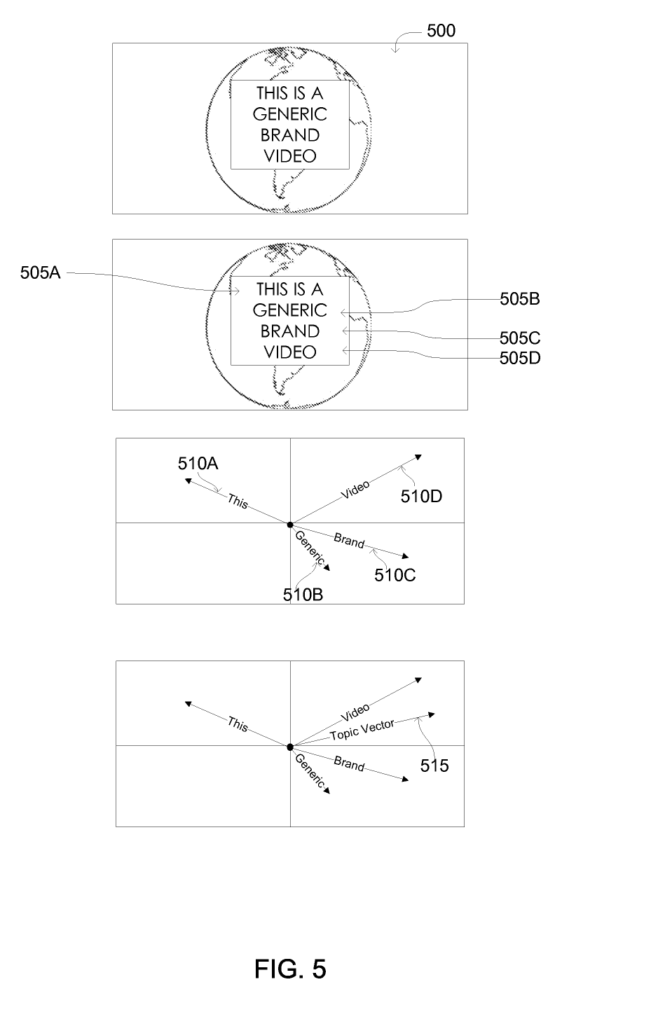

Based on the vectors determined from text objects included in the content item, the online system 140 determines a topic vector associated with the content item. The topic vector represents a topic associated with the content item in a topic vector space. In some embodiments, vectors associated with various text objects in the content item are averaged, and the topic vector is determined to be the average of the vectors associated with the text objects. In other embodiments, a weight is applied to a vector based on one or more context traits included in a tag of a text object corresponding to the vector. In various embodiments, higher weights are associated with certain types of context traits (e.g., at least a threshold font size, specific font types, specific font colors, specific locations of content from which words in a text object were extracted) than with other context traits. Different weights may be associated with different context traits, so a weight associated with a vector is a combination of weights associated with context traits included in a text object corresponding to the vector. For example, a larger weight is applied to a vector corresponding to a text object having a context trait indicating at least a threshold font size of the content from which the words in the text object were extracted than a weight applied to a vector corresponding to another text object indicating words in the text object were extracted from content having less than the threshold font size. Weights are applied to various vectors based on the context traits in the text objects corresponding to the vectors, and the topic vector is determined by averaging the vectors associated with various text objects after application of the weights to the vectors. In some embodiments, the online system 140 applies weights to a vector associated with a text object based on a degree of specificity associated with words in the text object. A degree of specificity associated with a word may be inversely related to a number of additional content items including the word, so a word included in fewer additional content items has a higher degree of specificity. For example, the word “red” is included in a larger number of content items than the word “golf,” so “red” has a lower degree of specificity than “golf.” In some embodiments, the topic vector associated with the content item is normalized when the topic vector is maintained 405 by the online system 140. An example determination of a topic vector for a content item is described below in conjunction with FIG. 5.

The online system 140 obtains 410 a subject content item for presentation to a user and extracts 415 text objects from the subject content item, as described above. In some embodiments, the subject content item is a content item that the online system 140 previously presented to the user. Alternatively, the subject content item is a content item the online system 140 has selected for presentation to the user but that has not been presented to the user. The subject content item may be obtained 410 from a third party system 130 or may be obtained from the online system 140 itself. As described above, the online system 140 determines 420 a vector for each of the text objects extracted from the subject content item and aggregates 425 the determined vectors to determine a topic vector representing the subject ad request in the topic vector space. Also as described above, weights may be associated with various vectors based on context traits in text objects corresponding to the vectors, and the vectors determined from the subject content item are aggregated by averaging the determined vectors after applying the weights to the determined vectors.

Based on the topic vector representing the subject content item and the topic vectors representing one or more of the reference content items in the topic vector space, the online system 140 identifies 430 a set of reference content items. In various embodiments, the online system 140 identifies 430 the set of reference content items based on distances between the topic vector representing the subject content item and the topic vectors representing various reference content items. For example, the online system 140 identifies 430 reference content items represented by topic vectors having less than a threshold distance to the topic vector representing the subject content item in the set of reference content items.

In other embodiments, the online system 140 identifies 430 the set of reference content items by applying a search method to the topic vector representing the subject content item and the topic vectors representing the reference content items to identify topic vectors representing the reference content items nearest to the topic vector representing the subject content item in the topic vector space. Reference content items represented by the topic vectors determined to be nearest to the topic vector representing the subject content item are identified 430 in the set of reference content items. Example search methods include: k-nearest neighbor methods, locality sensitive hashing methods, best bin first methods, k-d tree methods, fixed radius nearest neighbor methods, or any other suitable clustering methods. In some embodiments, multiple search methods may be applied to the topic vector representing the subject content item and the topic vectors representing the reference content items. For example, the online system 140 applies a library (e.g., Fast Library for Approximate Nearest Neighbors) including multiple search methods to the topic vector representing the subject content item and the topic vectors representing the reference content items to identify topic vectors representing reference content items nearest to the topic vector representing the subject content item in the topic vector space. Application of a library including multiple search methods may reduce time used to identify 430 the set of reference content items by optimizing the search method to identify topic vectors representing reference content items nearest to the topic vector representing the subject content item in the topic vector space based on characteristics of the topic vectors representing the reference content items and the topic vector representing the subject content item.

The online system 140 outputs 435 an association between the identified set of reference content items and the subject content item indicating the set of reference content items are similar to the subject content item. This association allows the online system 140 to more efficiently identify reference content items similar to the subject content item for presentation to one or more users. For example, the online system 140 associates identifiers of reference content items in the set with an identifier of the subject content item to indicate the reference content items in the set are similar to the subject content item. When additional content items are requested for presentation to a user to whom the subject content item was presented or for whom the subject content item was selected for presentation, the online system 140 uses the association between the set of reference content items and the subject content item to retrieve the reference content items to evaluate for presentation to the user. This allows the online system 140 to more quickly identify content items in which the user is likely to have an interest to evaluate for presentation.

FIG. 5 is an example of generating a topic vector associated with a content item 500. As described above in conjunction with FIG. 4, the online system 140 extracts text objects 505A, 505B, 505C, 505D (also referred to individually and collectively using reference number 505) from the content item 500. Each text object 505 includes one or more words from the content item 500, with the words extracted from the content item 500 via any suitable method, such as those described above in conjunction with FIG. 4.

The online system 140 determines vectors 510A, 510B, 510C, 510D (also referred to individually and collectively using reference number 510) associated with various text objects 505 extracted from the content item 500 through application of one or more word to vector processes to words included in various text objects 505. FIG. 5 shows the vectors 510 in a two dimensional Euclidean space for purposes of illustration, but the vectors 510 may include any suitable number of dimensions. The length of a vector 510 in the two dimensional representation of FIG. 5 indicates a weight associated with the vector 510 by the online system 140 based on context traits included in the text object 505 corresponding to the vector 510, based on a level of specificity of the words in the text object 505 corresponding to the vector 510, or based on any suitable information. The vectors 510 are aggregated by the online system 140 through any suitable method, as described above in conjunction with FIG. 4, to generate a topic vector 515 associated with the content item 505. For example, the topic vector 515 is generated by averaging the vectors 510. The online system 140 stores the topic vector 515 in association with the content item 500.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining a topic vector for each of a plurality of reference advertisement requests (“ad requests”), each topic vector representing the reference ad request in a topic vector space;
obtaining a subject ad request for display;
extracting a plurality of text objects from the subject ad request, each text object including one or more words;
determining a vector for each of the plurality of extracted text objects, each vector in the topic vector space;
aggregating the determined vectors of the plurality of text objects to determine a topic vector representing the subject ad request in the topic vector space;
identifying a set of reference ad requests based on distances of the topic vectors for the reference ad request to the topic vector of the subject ad request; and
outputting an association between the identified set of reference ad requests and the subject ad request as similar.

2. The method of claim 1, wherein a text object from the subject ad request further includes one or more context traits describing content of the received subject ad request from which the one or more words in the text object were extracted.

3. The method of claim 2, wherein a context trait is selected from a group consisting of: a font size, a font color, a font type, a location of content in the subject ad request from which the one or more words were extracted, and any combination thereof.

4. The method of claim 2, wherein aggregating the determined vectors of the plurality of text objects to determine the topic vector representing the subject ad request in the topic vector space comprises:
applying weights to one or more of the determined vectors, a weight applied to a determined vector based at least in part on one or more context traits included in a text object corresponding to the determined vectors; and
determining the topic vector as an average of the determined vectors after application of the weights to the one or more of the determined vectors.

5. The method of claim 1, wherein determining the vector for each of the plurality of extracted text objects comprises:
applying a model, the model previously trained by application of the model to a training set of text data, to the extracted text objects to determine the vectors for each of the plurality of extracted text objects.

6. The method of claim 5, wherein the training set of text data comprises data retrieved from one or more sources.

7. The method of claim 1, wherein identifying the set of reference ad requests based on distances of the topic vectors for the reference ad request to the topic vector of the subject ad request comprises:
applying one or more search methods to the topic vector of the subject ad request and the topic vectors of the reference ad requests to identify one or more topic vectors of reference ad requests nearest to the topic vector of the subject ad request in the topic vector space; and
identifying reference ad requests associated with the identified one or more topic vectors of reference ad requests as the set of reference ad requests.

8. The method of claim 1, wherein identifying the set of reference ad requests based on distances of the topic vectors for the reference ad request to the topic vector of the subject ad request comprises:
identifying one or more topic vectors of reference ad requests having less than a threshold distance to the topic vector of the subject ad request in the topic vector space; and
identifying reference ad requests associated with the identified one or more topic vectors of reference ad requests as the set of reference ad requests.

9. The method of claim 1, wherein extracting a plurality of text objects from the subject ad request comprises:
extracting one or more text objects from image data included in the subject ad request.

10. The method of claim 1, wherein extracting a plurality of text objects from the subject ad request comprises:
extracting one or more text objects from targeting criteria included in the subject ad request.

11. The method of claim 1, wherein extracting a plurality of text objects from the subject ad request comprises:
extracting one or more text objects from a landing page specified by the subject ad request.

12. A method comprising:
maintaining a topic vector for each of a plurality of reference content items, each topic vector representing the reference content item in a topic vector space;
obtaining a subject content item for display;
extracting a plurality of text objects from the subject content item, each text object including one or more words;
determining a vector for each of the plurality of extracted text objects, each vector in the topic vector space;
aggregating the determined vectors of the plurality of text objects to determine a topic vector representing the subject content item in the topic vector space;
identifying a set of reference content items based on distances of the topic vectors for the reference content items to the topic vector of the subject content item; and
outputting an association between the identified set of reference content items and the subject content item as similar.

13. The method of claim 12, wherein a text object from the subject content item further includes one or more context traits describing content of the received subject content item from which the one or more words in the text object were extracted.

14. The method of claim 13, wherein a context trait is selected from a group consisting of: a font size, a font color, a font type, a location of content in the subject content item from which the one or more words were extracted, and any combination thereof.

15. The method of claim 13, wherein aggregating the determined vectors of the plurality of text objects to determine the topic vector representing the subject content item in the topic vector space comprises:
applying weights to one or more of the determined vectors, a weight applied to a determined vector based at least in part on one or more context traits included in a text object corresponding to the determined vectors; and
determining the topic vector as an average of the determined vectors after application of the weights to the one or more of the determined vectors.

16. The method of claim 12, wherein determining the vector for each of the plurality of extracted text objects comprises:
applying a model, the model previously trained by application of the model to a training set of text data, to the extracted text objects to determine the vectors for each of the plurality of extracted text objects.

17. The method of claim 12, wherein identifying the set of reference content items based on distances of the topic vectors for the reference ad request to the topic vector of the subject content item comprises:
identifying one or more topic vectors of reference content items having less than a threshold distance to the topic vector of the subject content item in the topic vector space; and
identifying reference ad requests associated with the identified one or more topic vectors of reference content items as the set of reference content items.

18. The method of claim 1, wherein extracting a plurality of text objects from the subject content item comprises:
extracting one or more text objects from content associated with the subject content item.

19. A computer program product comprising a computer readable storage medium having instructions encoded thereon that, when executed by a processor, cause the processor to:
maintain a topic vector for each of a plurality of reference content items, each topic vector representing the reference content item in a topic vector space;
obtain a subject ad request for display;
extract a plurality of text objects from the subject content item, each text object including one or more words;
determine a vector for each of the plurality of extracted text objects, each vector in the topic vector space;
aggregate the determined vectors of the plurality of text objects to determine a topic vector representing the subject content item in the topic vector space;
identify a set of reference content items based on distances of the topic vectors for the reference content items to the topic vector of the subject content item; and
output an association between the identified set of reference content items and the subject content item as similar.

20. The computer program product of claim 19, wherein determine the vector for each of the plurality of extracted text objects comprises:
apply a model, the model previously trained by application of the model to a training set of text data, to the extracted text objects to determine the vectors for each of the plurality of extracted text objects.
